(19) United States
(12) Patent Application Publication
(10) Pub. No.: US 2017/0344971 A1
(43) Pub. Date: Nov. 30, 2017

(54) SYSTEM AND METHOD FOR A HIGH AVAILABILITY CLOUD ENABLED POINT OF SALE SYSTEM

(71) Applicant: IPDEV Co., Chicago, IL (US)

(72) Inventors: James B. Kargman, Chicago, IL (US); James Vitek, Ann Arbor, MI (US)

(21) Appl. No.: 15/609,700

(22) Filed: May 31, 2017

Related U.S. Application Data
(60) Provisional application No. 62/343,382, filed on May 31, 2016.

(51) Int. Cl. G06Q 20/20; G06F 3/0482

(52) U.S. Cl. CPC G06Q 20/201; G06F 3/0482

(57) ABSTRACT

A method implemented on a client device for displaying pricing information is described, for example, in a restaurant system having “bundle” pricing when purchasing predetermined groups of items. The client device can determine and display pricing information, even when a communication connection to a server is unavailable. A graphical user interface configured for sales transactions is generated. First order information for a first sales transaction is received via the graphical user interface and first pricing information for the first sales transaction is obtained from, and generated by, a remotely located server device using server pricing information. Second order information for a second sales transaction is received. Second pricing information for the second sales transaction is determined by the client device, including generating the second pricing information based on client pricing information located locally to the client device. Pricing information is displayed by the client device via the graphical user interface.

### CROSS-REFERENCE TO RELATED APPLICATIONS

This disclosure claims the benefit of U.S. Provisional Patent Application No. 62/343,382, entitled “System and Method for a High Availability Cloud Enabled Point of Sale System” and filed on May 31, 2016, the disclosure of which is incorporated herein by reference in its entirety.

### TECHNICAL FIELD

The present disclosure relates in general to a system and method for a high availability cloud enabled point of sale system.

### BACKGROUND

The growth of electronic commerce (e-commerce) systems across various industry segments has created challenges for companies with distributed operations, such as distributors and franchise organizations with hundreds of thousands of remote locations. Standalone computer systems in remote locations need to be connected over wide area network links, and these links present throughput and reliability challenges for communications. In addition, the load imposed on legacy systems (e.g., existing computers or point-of-sale devices) by modern e-commerce systems can often overwhelm these legacy systems.

Many commerce systems are divided into client-side activities and server-side (including cloud-based) activities. A point-of-sale (POS) or individual with a client-side application for accessing server-side information can access a significant amount of functionality and data from the server-side. However, for applications that are reliant upon significant server-side data and functionality, loss of a communication link to the server can effectively shut down functionality on the client side.

Additionally, virtualization of computer systems has become a widely used technology in the computer industry. Virtual systems provide operational benefits compared to physical systems, including the dynamic movement of virtual systems across physical host platforms.

One challenge that has been particularly difficult to solve, is the pricing of orders on e-commerce systems and assuring that they reflect the same price as calculated by the legacy system in the store. Legacy pricing solutions that may be thirty or more years old are not generally forward compatible with modern pricing solutions (e.g., cloud-based solutions).

Even where remote systems are capable of providing information and pricing responses to centralized e-commerce systems, they may have limitations in the number of requests they can support, and the speed and capacity of the communication links. Centralizing the pricing requests from thousands of remote point of sale (POS) systems is a very throughput intensive task, especially at peak loads, and in fact, at peak load, the capacity requirements can be orders of magnitude greater than the off peak loads. Saturation of remote links would result in a complete outage of the system, which is an unacceptable result in an enterprise system.

### SUMMARY

The ability to cache logic on the client (e.g., code and/or instructions that configure the client to provide software functionality) enables a cloud-enabled point-of-sale (POS) system to be both current and have high availability. Caching logic is a lower risk method to keep the client current than frequent updates that need to be “installed” at the OS layer, and can lower lifecycle maintenance and support costs over time. This client, providing POS functionality, can thus operate independently of the cloud for extended periods of time when the cloud is unavailable.

According to an embodiment, a graphical user interface configured for sales transactions is generated by a client device. First order information for a first sales transaction is received by the client device via a graphical user interface. The client device obtains first pricing information for the first sales transaction from a server device located remotely from the client device. The first pricing information is generated by the server device based on server pricing information located remotely from the client device. The first pricing information is displayed by the client device via the graphical user interface. Second order information for a second sales transaction is received by the client device via the graphical user interface. Second pricing information for the second sales transaction is determined by the client device, including generating the second pricing information based on client pricing information located locally to the client device. The second pricing information is displayed by the client device via the graphical user interface.

### BRIEF DESCRIPTION OF THE DRAWINGS

The description herein makes reference to the accompanying drawings wherein like reference numerals refer to like parts throughout the several views.

FIG. 1 is a block diagram of a distributed or cloud computing system.

FIG. 2 is a block diagram of an implementation of an internal configuration of a computing device, such as a computing device of the computing system as shown in FIG. 1.

FIG. 3 is a block diagram of an implementation of a high availability processing system.

FIG. 4 is a Venn diagram showing functionality of POS systems, OLO systems and shared functionality.

FIG. 5 is a block diagram illustrating the implementation of a cloud-based system according to an implementation.

FIGS. 6A & 6B are block diagrams according to an implementation of an enterprise POS architecture.

FIG. 7 is an example screen shot of a web-based interface that may be used to interact with the server side of the system.

FIG. 8 is a block diagram illustrating a system in which an order can be implemented on a POS or client-side or on a server side, according to an implementation.

FIG. 9 is a block diagram illustrating an implementation of a shadow virtualization system.

FIG. 10 is a flow diagram of an example method for displaying pricing information, according to an embodiment.

### DETAILED DESCRIPTION

### Description of Base System Components

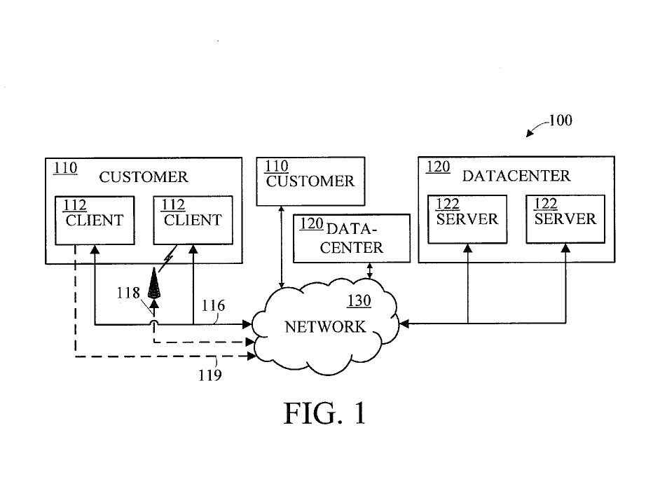

To describe some implementations in greater detail, reference is first made to examples of hardware structures and interconnections usable in implementations of the present disclosure. FIG. 1 is a block diagram of a distributed or cloud computing system 100. Use of the phrase “cloud computing system” herein is a proxy for any suitable form of a distributed computing system, and this phrase is used simply for ease of reference. Cloud computing system 100 can have any number of customers, including customer 110. Each customer 110 may have clients, such as clients 112. Each of clients 112 can be in the form of a computing system including multiple computing devices, or in the form of a single computing device, for example, a mobile phone, a tablet computer, a laptop computer, a notebook computer, a desktop computer, and the like. Customer 110 and clients 112 are examples only, and a cloud computing system may have a different number of customers or clients or may have a different configuration of customers or clients. For example, there may be hundreds or thousands of customers and each customer may have any number of clients.

Cloud computing system 100 can include any number of datacenters, including datacenter 120. Each datacenter 120 may have servers, such as servers 122. Each datacenter 120 may represent a facility in a different geographic location where servers are located. Each of servers 122 can be in the form of a computing system including multiple computing devices (e.g., a cluster), or in the form of a single computing device, for example, a desktop computer, a server computer, a virtual machine and the like. The datacenter 120 and servers 122 are examples only, and a cloud computing system may have a different number of datacenters and servers or may have a different configuration of datacenters and servers. For example, there may be tens of datacenters and each datacenter may have hundreds or any number of servers.

Clients 112 and servers 122 may be configured to connect to network 130. The clients for a particular customer may connect to network 130 via a common communication link 116 or different communication links, e.g. a wireless communication link 118 (e.g., provided by a wireless access point) and a wired communication link 119 (e.g., provided by a wired network switch or router). Any combination of common or different communication links may be present, and any combination of wired and wireless communication links may be present as well. Network 130 can be, for example, the Internet. Network 130 can also be or include a local area network (LAN), wide area network (WAN), virtual private network (VPN), or any other means of transferring data between any of clients 112 and servers 122. Network 130, datacenter 120 and/or blocks not shown may include network hardware such as routers, switches, load balancers and/or other network devices.

Other implementations of the cloud computing system 100 are also possible. For example, devices other than the clients and servers shown may be included in cloud computing system 100. In an implementation, one or more additional servers may operate as a cloud infrastructure control, from which servers and/or clients of the cloud infrastructure are monitored, controlled and/or configured. For example, some or all of the techniques described herein may operate on said cloud infrastructure control servers. Alternatively, or in addition, some or all of the techniques described herein may operate on servers such as servers 122.

In various embodiments, the customer 110 corresponds to a restaurant operator, franchisee, store manager, or other suitable operator of a point of sale or point of service. In various embodiments, the datacenter 120 corresponds to a restaurant central office, franchisor, regional manager, or other suitable centralized point of management of one or more customers 110.

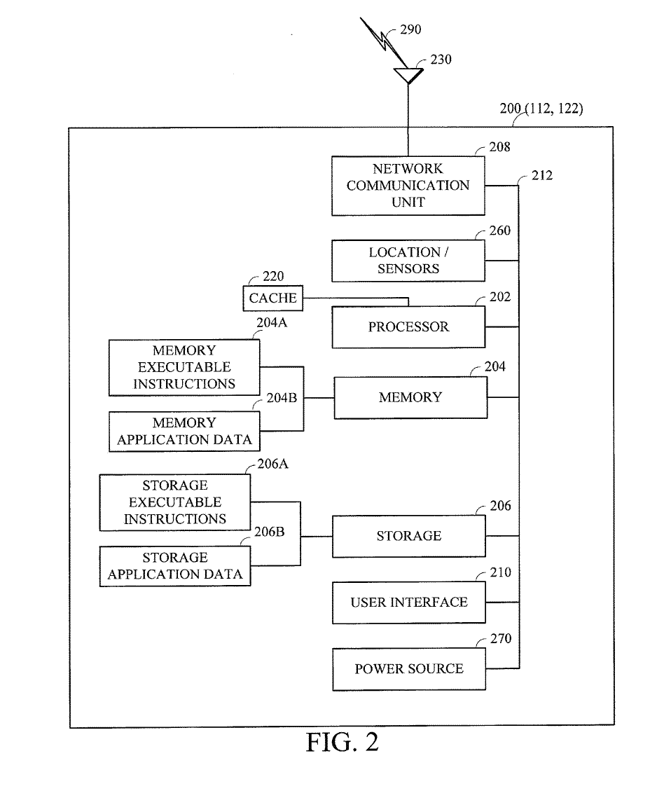

FIG. 2 is a block diagram of an implementation of an internal configuration of a computing device 200, such as a client 112 or server 122 of the computing system 100 as shown in FIG. 1, including an infrastructure control server of a computing system. As previously described, clients 112 or servers 122 may take the form of a computing system including multiple computing units, or in the form of a single computing unit, for example, a mobile phone, a tablet computer, a laptop computer, a notebook computer, a desktop computer, a server computer and the like.

The computing device 200 can include a number of components, as illustrated in FIG. 2. Processor 202 can be a central processing unit, such as a microprocessor, and can include single or multiple processors, each having single or multiple processing cores. Alternatively, processor 202 can include another type of device, or multiple devices, capable of manipulating or processing information now-existing or hereafter developed. When multiple processing devices are present, they may be interconnected in any manner, including hardwired or networked, including wirelessly networked. Thus, the operations of processor 202 can be distributed across multiple machines that can be coupled directly or across a local area or other network. The processor 202 can be a general purpose processor or a special purpose processor.

Random Access Memory (RAM) 204 can be any suitable non-permanent storage device that is used as memory. RAM 204 can include executable instructions and data for access by processor 202. RAM 204 typically comprises one or more DRAM modules such as DDR SDRAM. Alternatively, RAM 204 can include another type of device, or multiple devices, capable of storing data for processing by processor 202 now-existing or hereafter developed. Processor 202 can access and manipulate data in RAM 204 via bus 212. The processor 202 may utilize a cache 220 as a form of localized fast memory for operating on data and instructions.

Storage 206 can be in the form of read only memory (ROM), a disk drive, a solid state drive, flash memory, Phase-Change Memory (PCM), or any form of non-volatile memory designed to maintain data for some duration of time, and preferably in the event of a power loss. Storage 206 can include executable instructions 206A and application files/data 206B along with other data. The executable instructions 206A can include, for example, an operating system and one or more application programs for loading in whole or part into RAM 204 (with RAM-based executable instructions 204A and application files/data 204B) and to be executed by processor 202. The executable instructions 206A may be organized into programmable modules or algorithms, functional programs, codes, and code segments designed to perform various functions described herein. The operating system can be, for example, a Microsoft Windows®, Mac OS X®, or Linux® operating system, or can be an operating system for a small device, such as a smart phone or tablet device, or a large device, such as a mainframe computer. The application program can include, for example, a web browser, web server and/or database server. Application files 206B can, for example, include user files, database catalogs and configuration information. In an implementation, storage 206 includes instructions to perform the discovery techniques described herein. Storage 206 may comprise one or multiple devices and may utilize one or more types of storage, such as solid state or magnetic.

The computing device 200 can also include one or more input/output devices, such as a network communication unit 208 and interface 230 that may have a wired communication component or a wireless communications component 290, which can be coupled to processor 202 via bus 212. The network communication unit 208 can utilize any of a variety of standardized network protocols, such as Ethernet, TCP/IP, or the like to effect communications between devices. The interface 230 can comprise one or more transceiver(s) that utilize the Ethernet, power line communication (PLC), WiFi, infrared, GPRS/GSM, CDMA, etc.

A user interface 210 can include a display, positional input device (such as a mouse, touchpad, touchscreen, or the like), keyboard, or other forms of user input and output devices. The user interface 210 can be coupled to the processor 202 via the bus 212. Other output devices that permit a user to program or otherwise use the client or server can be provided in addition to or as an alternative to display 210. When the output device is or includes a display, the display can be implemented in various ways, including by a liquid crystal display (LCD) or a cathode-ray tube (CRT) or light emitting diode (LED) display, such as an OLED display.

Other implementations of the internal configuration or architecture of clients and servers 200 are also possible. For example, servers may omit display 210. RAM 204 or storage 206 can be distributed across multiple machines such as network-based memory or memory in multiple machines performing the operations of clients or servers. Although depicted here as a single bus, bus 212 can be composed of multiple buses, that may be connected to each other through various bridges, controllers, and/or adapters. Computing devices 200 may contain any number of sensors and detectors that monitor the computing device 200 itself or the environment around the computing device 200, or it may contain a location identification unit 260, such as a GPS or other type of location device. The computing device 200 may also contain a power source 270, such as a battery, so that the unit can operate in a self-contained manner. These may communicate with the processor 202 via the bus 212.

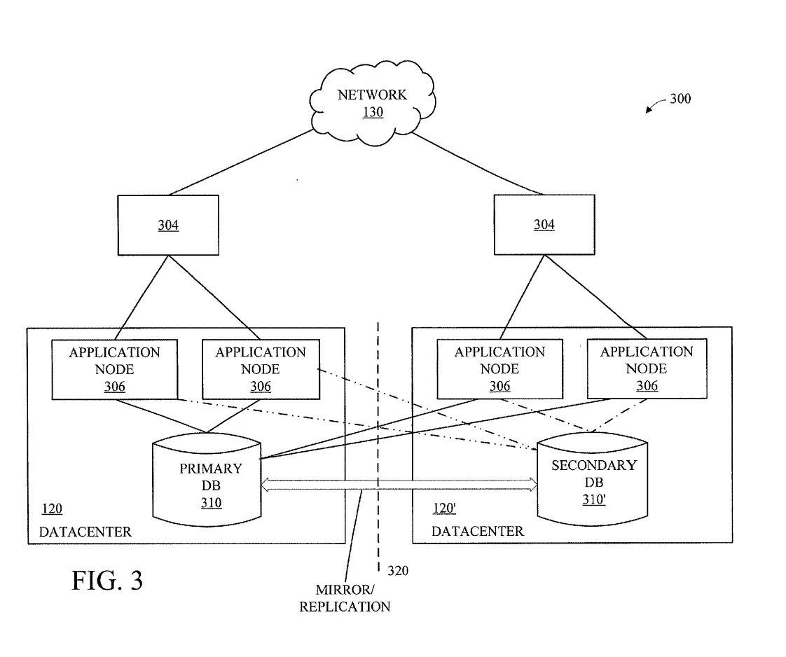

FIG. 3 is a block diagram of an implementation of a high availability processing system. The illustrated distributed computing system 300 can be, for example, an implementation of datacenter 120 and network 130 of FIG. 1. Broadly, the system 300 includes load balancers 304 and datacenters 120. The load balancers 304 are coupled to a telecommunications network graphically depicted by network 130. Load balancers 304 may also include reverse proxy load balancers.

A first datacenter 120 includes a primary database 310, and a second datacenter 120 includes a secondary database 310′. The datacenters 120 operate in such a manner that the secondary database 310′ can provide an exact or substantially exact mirror of the primary database 310. A dividing line 320 is used to graphically emphasize the logical boundary between datacenters 120. Depending upon the intended application, the databases 310, 310′ may be implemented using, for example, a relational database management system (RDBMS), an object database, an XML database, flat files, or the like. In an implementation, datacenters 120 include web servers (e.g., Apache installations) implemented on physical hardware servers (e.g., servers 122 of datacenter 120 of FIG. 1) for processing client requests to access resources of a customer computer network.

Each datacenter can include application nodes 306, although a greater or lesser number than illustrated can be used depending on the implementation. The application nodes can be implemented using processing threads, virtual machine instantiations, or other computing features of the datacenters that run programs on behalf of remotely sited clients, and exchange related data with such clients via the network 130. In connection with running these programs, occasions arise for the application nodes to store and retrieve data, with the databases 310 filling this role. In an implementation, each of the application nodes connects to a single primary database, regardless of whether said database is located in the same datacenter as said application node. For example, a primary database may be read/write and a secondary database may be configured to be read-only such that it mirrors changes from the primary database. Requests to the system 300 may be routed to the application nodes in the datacenter of the primary database first, followed by the other datacenter. In a failover situation, the secondary database may become read/write with the formerly primary database switched to mirror the secondary database (which becomes the primary database). In this situation, each application node can be reconfigured to point to the secondary database (now the primary database) as shown by the dashed lines. In this situation, each application node can be reconfigured to point to the secondary database (now the primary database) as shown by the dashed lines.

As mentioned above, each datacenter 120 may have its own load balancer 304. Each load balancer 304 may be configured to direct traffic to respective servers and processing nodes located within its datacenter. In regard to proxy services, in one example the load balancers 304 are configured to provide a single Internet-delivered service to remote clients via the network 130, where this service is actually provided by a server farm composed of the computerized servers of the datacenters 120. The load balancers 304 can also coordinate requests from remote clients to the datacenters 120, simplifying client access by masking the internal configuration of the datacenters. The load balancers 304 may serve these functions by directing clients to processing nodes as configured directly or via DNS. The load balancers 304 can be configured for sticky sessions. With sticky sessions, requests from a client can be forwarded to the same application node 306 for the duration of the client session.

In regard to load balancing, the components 304 can be configured to direct traffic to the secondary datacenter 120′ in the event the primary datacenter 120 experiences one of many enumerated conditions predefined as failure. The load balancing functionality of the load balancers 304 can be provided as separate components or as a single component.

The distributed computing system 300 can allocate resources of a computer network using a multi-tenant or single-tenant architecture. Under a multi-tenant architecture, installations or instantiations of application, database, and/or other software application servers may be shared amongst multiple customers. For example, a web server (e.g., a unitary Apache installation), application server (e.g., unitary Java Virtual Machine) and/or a single database server catalog (e.g., a unitary MySQL catalog) may handle requests from multiple customers. In an implementation of this architecture, the application and/or database server software can distinguish between and segregate data and other information of the various customers using the system.

In a single-tenant infrastructure, separate web servers, application servers, and/or database servers can be provisioned for each customer instance. In an implementation, each customer will access its dedicated web server(s), will have its transactions processed using its dedicated application server(s), and will have its data stored in its dedicated database server(s) and or catalog(s). Physical hardware servers may be shared such that multiple installations or instantiations of web, application, and/or database servers may be installed on the same physical server. Each installation may be allocated a certain portion of the physical server resources, such as RAM, storage, and CPU cycles.

In an implementation, a customer instance comprises multiple web server instances, multiple application server instances, and multiple database server instances. The server instances may be located on different physical servers and share resources of the different physical servers with a number of other server instances associated with other customer instances. In a given cloud computing system, different implementations of customer instances may be used for different customer instances at the same time. Other configurations and implementations of customer instances may also be used. For example, in an implementation, web server and application server functionality are treated as a single unit (of which there may be multiple units present), each unit being installed on respective physical servers.

### High Availability POS System

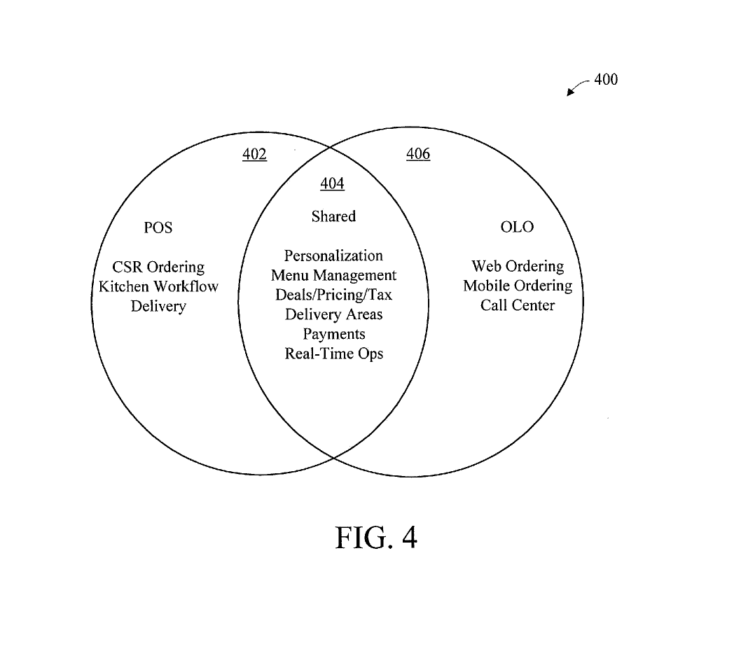

An implementation of an advanced high availability point of sale system is disclosed herein. The system may employ features that have traditionally been a part of an on-line ordering system, such as a web ordering system. FIG. 4 is a Venn diagram 400 showing point-of-sale functionality 402 normally associated with a point-of-sale (POS) system, that focuses on an order cycle, and on-line-ordering (OLO) functionality 406, for example, functionality for a restaurant or kitchen that provides a delivery service. The POS functionality 402 may include one or more of customer service representative (CSR) ordering (in which a customer interacts with a CSR to place an order), kitchen workflow (including scheduling), and the logistics associated with delivery. The OLO functionality 406 may include one or more of web ordering, mobile device ordering, and a call center. However, at least some functionality may be shared (shared functionality 404) between the POS functionality 402 and the OLO functionality 406. The shared functionality 404 includes one or more of personalization of the ordering experience, menu management, deals/pricing/tax, delivery areas, payments, and other real-time operations, in an embodiment. In the system described herein, flexibility is provided for implementing various functions associated with either the POS functionality 402 or with the OLO functionality 406. The POS functionality 402 is shifting more and more towards consumer devices with orders being placed directly by consumers via a mobile device or on-line ordering. The cash register on the front counter is becoming relatively less important as it is not used as much. The OLO functionality 406 may encompass web ordering, mobile ordering, and call center ordering.

As used herein, a POS can include a traditional POS device, and can allow an end-user to interact directly with a server. The primary difference between the traditional POS and direct interaction by the end user is that the traditional POS merchant will have some control over the pricing and deals, whereas the end user who directly interacts with the web page will not. Furthermore, an authorized user at the traditional POS can make modifications to a customer account that a customer may not be permitted to make on their own. Additionally, it is more important for a traditional POS to be operational in order to conduct business with customers who visit the establishment in person or contact it through other means (such as a telephone) than for a customer as an end-user who wishes to place an order by interacting with a food ordering website.

Also, the user experience/user interface can be configured differently for the traditional POS as opposed to the customer as end-user. For the POS, the user experience for employees is optimized based on efficiency and speed. In contrast, the end-user web experience is optimized based on first-time ease of use, visual appeal, and branding. For example, big food pictures on a homepage of a food website may be preferable for selling end-users on a new product or bundle deal, but in a POS context, such a display might cause unnecessary interactions with the display and take up valuable screen real-estate that may be better used for things like a script of how to interact with the customer. In a pizza context, a picture of a pizza that is updated as a customer as end-user adds toppings may be visually appealing to the customer, but would waste space in a POS context.

Finally, the POS in a store will likely have more options for the operator in the store than a person at home. For example, it may have a scheduling function for scheduling the order for preparation and delivery, particularly with respect to an ability to schedule orders to be prepared in the sequence they will be delivered. As orders are received or entered, they are sequenced for preparation and baking depending on a predicted availability of delivery drivers returning from delivery runs. The POS is designed to handle a particular volume of simultaneous orders, which should be coordinated, as opposed to the single-order focus of the customer as end user.

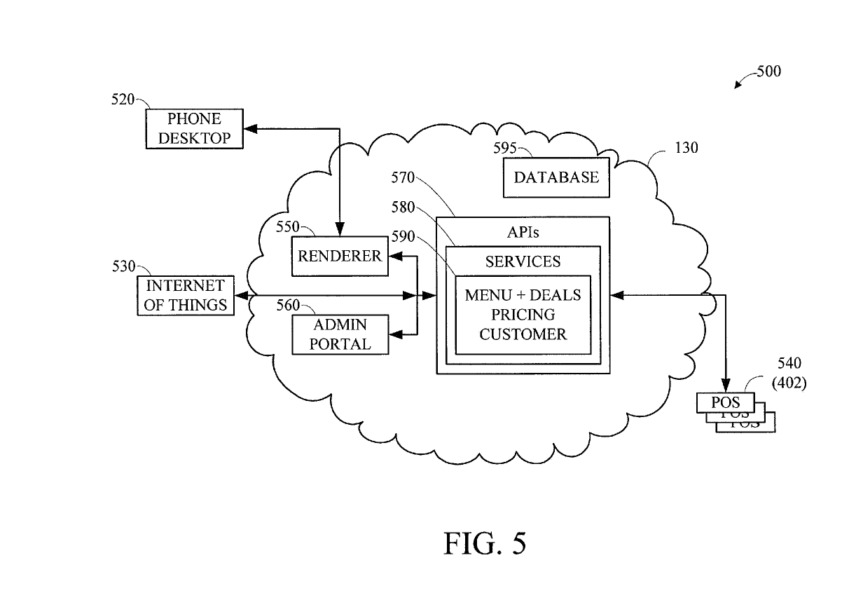

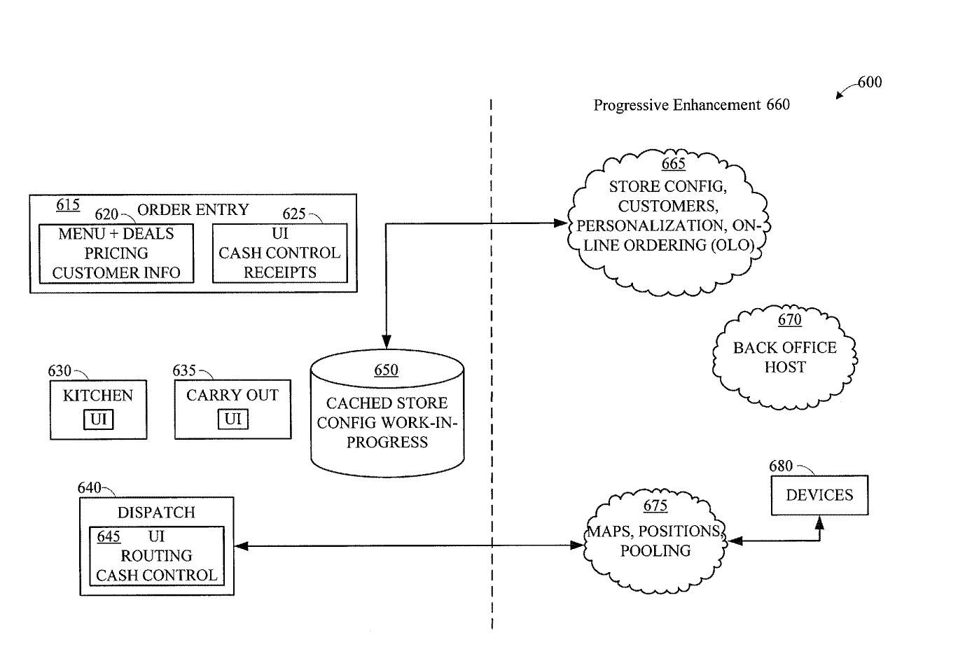

FIG. 5 is a block diagram illustrating the implementation of a cloud-based system 500 that may be used. A user device 520 (e.g., smart phone, desktop computer, or tablet) 520 may interact with a renderer 550 located within the network/cloud 130. The renderer 550 is configured to render a web page or other suitable user interface (UI) display to be provided to the user device 520. The renderer 550 may interact with cloud-based services 580 to access ordering services logic 590 such as getting a current menu along with deals, pricing, and other customer data, using application program interfaces (APIs) 570 and an API platform (not shown). The renderer 550 and/or API platform are implemented on the server 122, data center 120, or other suitable device, in various embodiments. A cloud 130, as defined herein, can include any network architecture that allows a plurality of devices to be interconnected and communicate with one another. Other devices that may include those considered to be a part of the Internet of Things (IoT) 530, which may not have a dedicated user interface and thus may interact directly with the APIs 570. The user device 520 and IoT 530 provide channels via which orders may be received from. The cloud 130 can also have a queue (not shown) that contains information about work-in-progress, but this can also be present client-side. Also, the point-of-sale systems 540 can utilize the APIs 570 to access the various services 580 offered in the cloud. An administrative tool/portal 560 can be used to configure and administer the system, and a database 595 can contain pertinent data to the e-commerce system.

In an embodiment, one or more of the user device 520, IoT 530, and POS 540 are clients 112 of a customer 110, while the renderer 550, administrative tool/portal 560, APIs 570 or API platform, cloud-based services 580, and database 595 correspond to a server 122 or other suitable device of the datacenter 120. In an embodiment, the client 112 provides the POS functionality 402, the server 122 provides the OLO functionality 406, and both the client 112 and the server 122 provide at least some of the shared functionality 404.

According to an implementation, the APIs support versioning that allows making future variations while providing legacy support to the API calls. The API calls may be designed for localization, i.e., to support multiple languages, and an API call can return translated content in an appropriate language (e.g., menus, coupons, error messages, etc.). However, the currency symbols and formatting need not be dependent on the language requested from the API. In an implementation, the API is stateless or RESTful, without using traditional sessions (cookie based or other form). Each API call can utilize a request header token for authorization—when a user logs in, the login API can return an authorization token to be saved to the browser's local storage, and this authorization token can be used for future API calls to determine the result of the call. These calls may be done over SSL or forced SSL (HTTPS).

The API can be designed to use proper HTTP verbs: POST if something is being created; PUT if something is being updated; GET if something is being retrieved, and DELETE if something is being deleted. The API may return proper status codes based on a response result, e.g.: 200 status for success, 401 status if unauthorized, 400 status if error, and 404 if not found.

Whenever an object is being modified (POST, PUT), the resulting response may include the latest version of that object. The API may include the following list of calls that are provided by way of example only. The list of calls may include others not provided here.

Table 1 provides a list of possible user-related calls.

TABLE 1
Example User API Calls

| | | Auth | |
|---|---|---|---|
| Method | Call | Rq'd | Result |
| POST | /v1/users/ | No | Creates the new user and also |
| | | | returns an authorization token. |
| PUT | /v1/users/1/ | Yes | Updates the user's data |
| GET | /v1/users/1/ | Yes | Gets the user's data |
| DELETE | /v1/users/1/ | Yes | Deletes the user |
| POST | /v1/login | No | Returns an authorization token |
| POST | /v1/logout | Yes | Destroys the authorization token |
| GET | /v1/users/1/orders | Yes | Gets a list of all orders by the |
| | | | user |
| GET | /v1/users/1/orders/1 | Yes | Gets the details on one order by |
| | | | the user |

Table 2 provides a list of possible address validation calls. Validating a user's given address may be utilized for determining location and store options. The address validation may be a separate API to determine the results of a user's address request.

TABLE 2
Example Address Validation API Calls

| | | Auth | |
|---|---|---|---|
| Method | Call | Rq'd | Result |
| POST | /v1/address-validation/ | No | Validates the details of a user's |
| | | | address query (may utilize a |
| | | | third party such as Google |
| | | | Maps API). |

Table 3 provides a list of possible store-related calls for retrieving information about the stores.

TABLE 3
Example Store API Calls

| | | Auth | |
|---|---|---|---|
| Method | Call | Rq'd | Result |
| GET | /v1/stores/?latlng | No | Returns a list of stores based on |
| | | | provided latitude and longitude. |
| GET | /v1/stores/?address | No | Returns a list of stores based on |
| | | | address query. |
| GET | /v1/stores/1/ | No | Returns all store data, including |
| | | | a menu ID |

Table 4 provides a list of possible menu-related calls for retrieving information about a menu. Menus may be independent of stores. A menu can be a little more extensive, because in most contexts this can be “hidden” behind the store selection UX. These API calls may return coupons with the menu, and provide a front-end translation JavaScript library.

TABLE 4
Example Menu API Calls

| | | Auth | |
|---|---|---|---|
| Method | Call | Rq'd | Result |
| GET | /v1/menu/1/ | No | Retrieves all of the menu data. |

Table 5 provides a list of possible cart-related calls for storing a user's cart. The cart lists all of the products the user intends to buy, but hasn't purchased yet. Carts do not have to use sessions, but instead, may use an ID to retrieve cart details via the API.

TABLE 5
Example Cart API Calls

| | | Auth | |
|---|---|---|---|
| Method | Call | Rq'd | Result |
| POST | /v1/carts/ | Yes | Creates a cart. |
| PUT | /v1/carts/1/ | Yes | Update a cart, can provide order |
| | | | validations, pricing not necessary |
| | | | but could be provided based on the |
| | | | capabilities of the platform, could |
| | | | provide order information such as |
| | | | instructions to complete an order, |
| | | | coupons, recommendations. |
| GET | /v1/carts/1/ | Yes | Gets the cart. Includes taxes, fees, |
| | | | all calculations. |
| DELETE | /v1/carts/1/ | Yes | Deletes the cart |

Table 6 provides a list of possible order-related calls, which may be made to create an order, based on a cart ID. All order endpoints should be secure, given that the request may potentially include payment data. An order should only be placed by the user who created the order, and an order may be marked as “placed” through this service.

TABLE 6
Example Order API Calls

| | | Auth | |
|---|---|---|---|
| Method | Call | Rq'd | Result |
| POST | /v1/orders/?cartID | Yes | Creates a new order. |
| GET | /v1/orders/ | Yes | Gets list of orders |
| | | | (based on authorized user) |
| GET | /v1/orders/1/ | Yes | Gets the order data. |

Table 7 provides a list of possible pricing-related calls for pricing information. Pricing may be centralized in most cases (i.e., not left to the client).

TABLE 7
Example Pricing API Calls

| | | Auth | |
|---|---|---|---|
| Method | Call | Rq'd | Result |
| GET | /v1/cart/1/pricing | Yes | Retrieves pricing information |
| | | | about the cart. |

Table 8 provides a list of possible content-related calls for content. Some of the content (e.g., ads, promo tiles) may need to be dynamic and served via the API, and the content calls may be loosely structured. If content needs to be provided, a restful interface could be used to retrieve content. Specific content may be provided for specific environments or devices, and content could be associated to stores.

TABLE 8
Example Pricing API Calls

| | | Auth | |
|---|---|---|---|
| Method | Call | Rq'd | Result |
| GET | /v1/content/1/ | No | Retrieves content object |
| | | | (text, image, video, etc.). |

Some endpoints, that could be public, could be useful to reduce menu size and responsiveness (e.g., /products/might be used on a product per product basis, if a product such as a pizza has a complex configuration data).

In the architecture shown in the cloud-based system 500 of FIG. 5, the services logic 590 can be implemented using JavaScript, and the services 580 can be provided in cloud containers using, e.g., Docker® (Docker, Inc., http://www.docker.com) and Node.js,® which is a JavaScript runtime built on Google's Chrome V8 JavaScript engine. The APIs 570 may be implemented using a representational state transfer (REST)-ful architecture. A high-availability cloud-based service, such as Microsoft's Azure,® Amazon Web Services,® or Google Web Services® may be used.

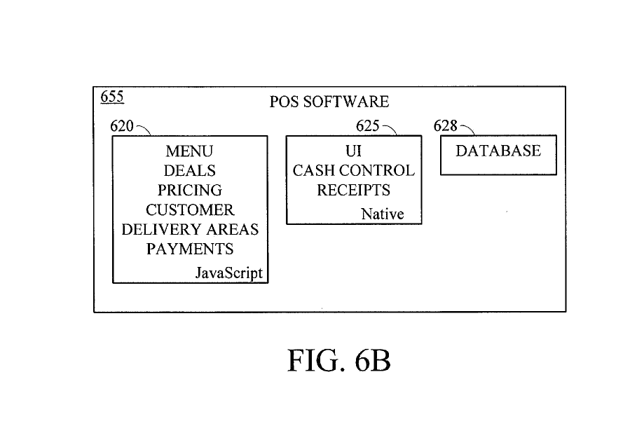

FIG. 6A is a block diagram according to an implementation of an enterprise POS architecture 600. This architecture is broken into two parts: an in-store part 610 and a progressive enhancement part 660. The in-store part 610 comprises an order entry system 615 that comprises a first section 620 for one or more of providing the menu, deals, determining the pricing, storing customer information, managing delivery areas, and handling payments. The in-store part 610 also includes a second section 625 that comprises one or more of the user interface, cash control, and receipts. The in-store part 610 also comprises the kitchen system 630 along with a user interface and carry-out system 635 along with a user interface. The in-store part 610 also comprises a dispatch system 640 comprising elements 645 for routing and cash control, along with a user interface. A cached store or database 650 can be provided for storing work-in-progress (e.g., orders that have been started but not yet finalized and entered).

The progressive enhancement part 660 comprises a first cloud-based portion 665 that contains information on store configurations, customers, personalization, and OLO. In some scenarios, the cloud-based portion 665 shares data with the cached store 650. The progressive enhancement part 660 also comprises a back office host 670 that provides back office functionality for the system focusing on the business cycle—this functionality includes, for example, one or more of forecasting, inventory, labor, time clock, and reporting functionality. The progressive enhancement part 660 also comprises geographical information 675, such as maps, positions, and pooling that may interface with the dispatch system 640 and communicate geographical (and other) information with devices 680.

FIG. 6B is a block diagram that further elaborates on the in-store part 610 and illustrates POS software 655 for the order entry system 615. In the embodiment shown in FIG. 6B, the POS software 655 includes the first section 620, the second section 625, and a database 628 (e.g. database 650). In an embodiment, the first section 620 (menu, deals, pricing, etc.) is implemented as a portable portion configured to be portable between different POS devices, tablets, smartphones, or other suitable devices. The portable portion is implemented with JavaScript, in an embodiment. In some embodiments, the second section 625 is implemented as a native portion, for example, one or more applications, scripts, libraries, modules, or other suitable instruction format written and/or compiled for an operating system and/or hardware of the device on which the POS software 655 is installed.

One or more portions of the enterprise POS architecture 600 are implemented by the computing system 100, in various embodiments. In an embodiment, for example, one or more client devices 112 implement the in-store part 610 and one or more servers 122 implement the progressive enhancement part 660. In an embodiment, the client 112 implements the POS software 655.

In various embodiments, the client device 112 utilizes a pricing portion of the first section 620 to determine pricing information (e.g., a total amount due) for a sales transaction. In an embodiment, for example, a sales transaction corresponds to order information for a cart and, based on items and their quantities in the cart, the client device 112 determines the total amount due that reflects coupons, promotional deals, combination deals (e.g., two or more items that provide a discount when purchased together).

In some embodiments, the first section 620 includes a payment handling section that interfaces with a cryptocurrency system (e.g., Bitcoin, Ethereum, Litecoin, etc.; not shown) or other suitable digital payment system. In an embodiment, the first section 620 communicates with a third party application executed on the client device 112 for handling payment via the cryptocurrency system. In an embodiment, the first section 620 includes a pricing section that adjusts pricing or deals based on a selected payment system. For example, the pricing section determines different prices for a given sales transaction based on whether a cash payment, credit card payment, or cryptocurrency payment is selected.

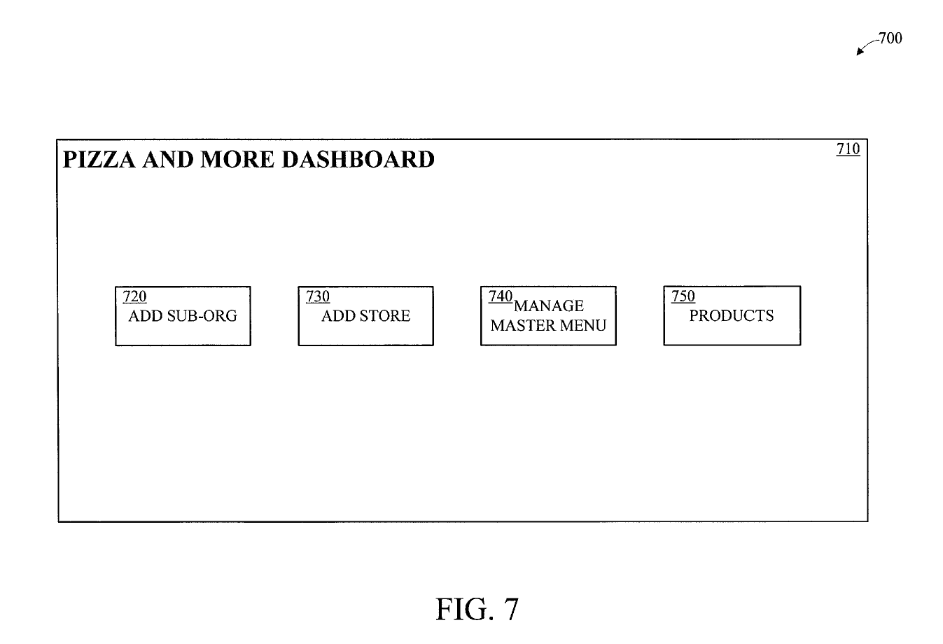

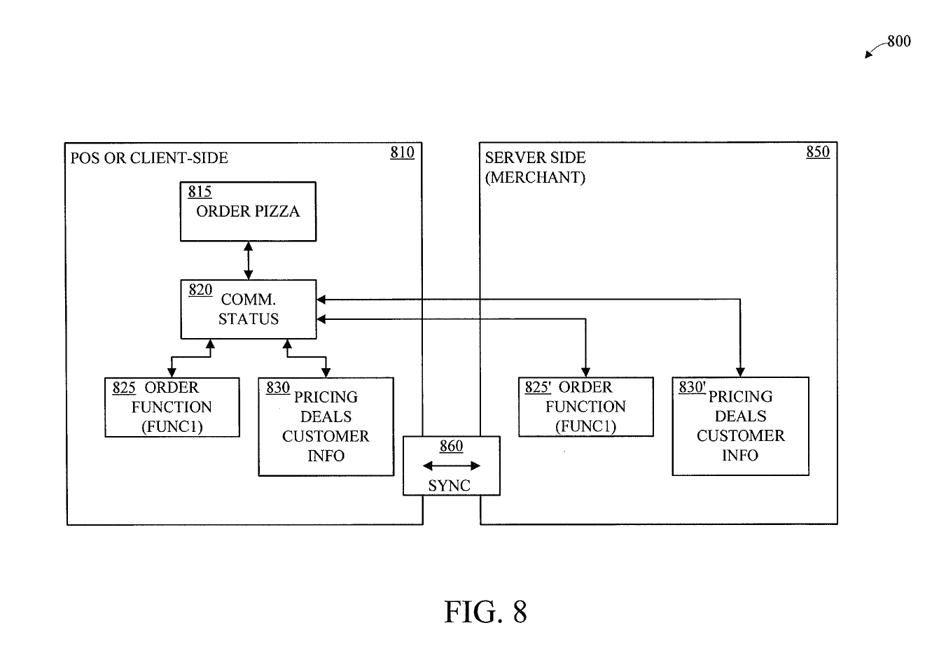

FIG. 7 is an example screen shot of a web-based interface 700 that may be used to interact with the server side of the system (e.g., server side 850, FIG. 8). It includes an example configuration dashboard 710 that allows entry of a sub-organization 720, which provides a tree structure for store definition data so that an inheritance scheme can be used to easily manage configurations for, e.g., thousands of stores. The dashboard 710 also allows a manager to add a store 730, manage a master menu 740, and enter information about products 750. In general, the dashboard 710 may be implemented as an admin tool that is used to enter and maintain product information for the e-commerce site. There may be significant overlap between the administration of stores and online implementation, and thus, doing the configuration once can provide a configuration of both the store and the online implementation.

The system benefits from a high or continuous availability because downtime of an ordering system can result in significant hits on revenue. Therefore, according to an implementation, server-side software updates (which may take extended periods of time to install) can be provided on a temporary system, and once all updates have been installed, the temporary system can become the production system by performing a cut-over. In this way, the transition to the update may be generally transparent to the customers and will result in little or no disruption in the operation of the services provided.

In an embodiment, functionality of the POS 402, 540 is based on a hosted system running on a tablet or smartphone utilizing an iOS or Android platform (e.g., client 112), and thus could be run on a customer device. In an implementation, the POS may have a significant degree of survivability, even when the network connection is down, meaning the device and system will be able to function for most of its functionality, even if certain core functionality features may operate in a somewhat degraded mode.

According to an implementation, when a communication link is down (e.g., communication link 116 or 118), many of the tasks of order entry can still take place. For example, data such as the menu, deals, pricing, and customer information utilized during order entry could all be replicated at the POS or on the customer device (e.g., client 112). In addition to just data, however, the actual logic, e.g., functions in the form of JavaScript or other suitable instruction format or code, could also be replicated and cached to run client-side even when the communication link is down. In an embodiment, for example, functions that provide one or more of a user interface for product selection and/or customization, cart management, pricing determination (e.g., product prices, discounts, taxes, order totals), payment details, or other portions of the in-store part 610 (e.g., kitchen system 630, carry-out system 635) are stored on the client 112.

FIG. 8 is a block diagram illustrating a system 800 in which an order can be entered on a client-side 810 or on a server side 850, according to an embodiment. The client-side 810 is implemented on a POS or client 112 and the server side 850 is implemented on one or more servers 122, in an embodiment. In a first situation, normal communications are present (e.g., a suitable communication connection for data transfer is available) on a communication link between the client-side 810 and the server side 850 (e.g., communication link 116 or 118). This determination of normal communications may be made by a communication status utility 820 (e.g., an executed process or thread) that monitors the communication status of the corresponding communication links. In this first situation, an order function 825′ implemented on the server side is utilized for placing orders. Information related to an order, such as the pricing, deals or discounts, and customer information 830′ may be accessed and the logic for a particular order is utilized by the order function 825′. For example, a customer may be offered a free drink if either of the following is true: a) the order total is greater than twenty dollars; and b) the customer has been a customer for more than one year. This logic, which may be written in JavaScript, accesses information from the pricing and deals data, along with the customer information 830′. On the server side 850, it can be presumed that all of the relevant information is up-to-date.

In a second situation, the communication status utility 820 determines that the communication link between the client-side 810 and the server side 850 is down. However, this does not shut down all aspects of placing an order. In this second situation, order function 825 and/or associated logic, along with the relevant data on pricing, deals, and customer information 830, are utilized, which have been previously downloaded to a memory accessible by the client-side 810 (e.g., cache 220, memory 204, storage 206 of computing device 200, database 628, database 650). This can be done according to a synchronization function 860 that operates to synchronize data and logic on both the client-side 810 and the server side 850. In an embodiment, one or both of the order function 825 and information 830 correspond to the shared functionality 404, as described above with respect to FIG. 4. In an embodiment, the order function 825 and information 830 correspond to the first section 620, as described above with respect to FIG. 6B.

The synchronization may be triggered by either a timer expiration that is set to synchronize at some predefined interval (e.g., every 100 milliseconds, every 3 seconds, or other suitable interval), upon some event occurring, such as client device power-up, an express request to sync from the client, an execution of an activity, such as starting or modifying an order, etc. Thus, various aspects of the order, such as the pricing rules, the deal or discounts, the logic, etc. can be implemented on the client side in the same way most of it could be implemented server side. Use of JavaScript may allow the same or nearly the same code to be executable both on the client-side 810 and the server side 850 without necessitating maintaining different code depending on the platform. A further benefit is that since the code is the same or nearly the same on the client side as on the server side, the user experience is the same when performing the requested function. The definition of the “store” (store configuration) that is stored in the database 830, 830′ can contain its attributes, the items the store sells, its pricing structure, and discounts that exist. The POS and the cloud may have the same behavior because they run the same JavaScript library, even if the underlying hardware or OS architecture is different.

Ultimately, the order itself may not be able to take place from a device to which the communication links are not functioning. However, certain limited functionality may still be able to take place, and various other aspects of the order can be set up so that once the communications are reestablished, the order can immediately proceed. For example, the POS system might not be able to take credit cards for example, but it might be able to keep track of an order, put up an order on the make-line display or print out a make-line ticket, and print out a receipt to the customer. Also, the system could offer to take a credit card order without authorization (and thus at a higher rate). The logic could apply so that the non-authorized credit card order is only allowed for repeat customers who have paid with a credit card before.

According to an implementation, in the event of a discrepancy in pricing, in a POS context, the code executing at the client has priority over code executing at the server. Prices can change on a daily basis in a large enterprise. Once the price is calculated and saved, it is not revisited. However, in a web e-commerce context, the server would compute the master price in the cloud. This prevents hackers from placing orders for free pizza based on a hacked JavaScript pricing module.

The ability to replicate functionality (e.g., synchronize the data and logic) between the client-side 810 and the server side 850 can also permit delineating functionality between the two based on processing power and other availability factors. If the communications network is down, but the telephone system is still available, then the client-side 810 could revert to placing the resultant order via the telephone system. Functionality to the client-side 810 could increase as these devices get more and more capability.

Since certain logic can be pushed to a portable execution environment, like JavaScript, it can be executed independently by different devices for performance or survivability purposes. The relevant data 830 may be represented as a binary large object (blob) of data in a form such as JavaScript Object Notation (JSON). Even though the data is maintained in a large blob, the advantage of storing it this way is that it is all located in one spot. So even though, e.g., the information surrounding ordering a pizza is complex, there are only a few dozen items that are for sale in any given store.

A cart in a store at the point of sale, or a consumer's cart in a browser running locally, can easily access the complex rules that govern a price of an item through a portable function and logic provided in, e.g., JavaScript to determine the price for all of the items in the cart given all of the complex rules that may be involved in pricing a pizza. The portable logic can be provided anywhere, in the cloud, on a tablet running a point-of-sale system, embedded in an app running in the user's smart phone, so that everything can be priced instantly. This makes the application more survivable because important features are running locally—it is not reliant on a communication connection to the server side 850. The user can populate items in their cart, price them, sell them, and then move on.

The system is particularly advantageous when the entire catalog of available items to order is relatively small and can easily be cached/stored on local devices. The ability to catalog and cache locally and allowing the application to be run wherever desired in a portable environment can thus be advantageous. For example, in a use case where a user wishes to add a product to a cart, if the “add to cart” function is server-based, then loss of a communication connection (e.g., when a suitable communication connection for data transfer is not available) prevents the user from adding the product to her cart. With the system described herein, the “add to cart” function can be implemented on the user's device, and thus can be successfully executed, even when the communication connection is down. The local function updates the cart data locally, and this information may be synchronized later on when the connection is reestablished.

Code executed on the client-side 810 can be subjected to “minification,” which reduces the size of the code and provides a degree of security by way of obfuscation. Authentication routines may be implemented in a native application on the client-side 810, and the code may be placed in a wrapper so that the code may be tied to a proprietary device, such as a user's smartphone or a POS device (e.g., client 112). In an embodiment, the client-side 810 has software that enables it to synchronize with software and data in the server-side 850 and provides an activation feature, for example, a license check to ensure that the device client-side 810 is authorized and authenticated. In other words, the client-side 810 is configured to receive software, information, and/or data updates from the server-side 850, provided that the client-side 810 is authenticated.

The client-side 810 may also utilize an encryption certificate to ensure secure communications between the client-side 810 and server-side 850 and to move credit card information or personally identifiable information. Since the system may contain a considerable amount of customer information, including customer history data, maintaining the data in a secured manner may be a feature of the system. A logging application may be provided on either or both of the client-side 810 and the server-side 850 so that it can be determined who has accessed customer data. In an implementation, a serial number of a device of the client-side 810 may be linked to licensing of the software (e.g., managed by on the server-side 850), and part of a security system of the server-side 850 can ensure that data received from one device cannot be accessed by another device—i.e., the received data may be tied to a particular device or tied to an organization (e.g., a POS organization, franchise location, franchise group, etc.).

### Shadow Virtualization

Another feature of a high availability POS system provides a way of “shadowing” a physical or “active” system, local or remote, with a virtual copy or “standby” of that system in a datacenter or the cloud, for backup operation (preferably immediate backup operation), and for duplication of processes without affecting the real world system state (e.g., records of completed and in-progress orders, customer information, price information, etc. on the active system). A method is provided that assures an effective synchronization of functions and data only to the extent required for the implementation and proper operation of functional components, to avoid the risks of “data in two places can be different” and for assuring that security information is not compromised by duplicating security information on physical and virtual images systems.

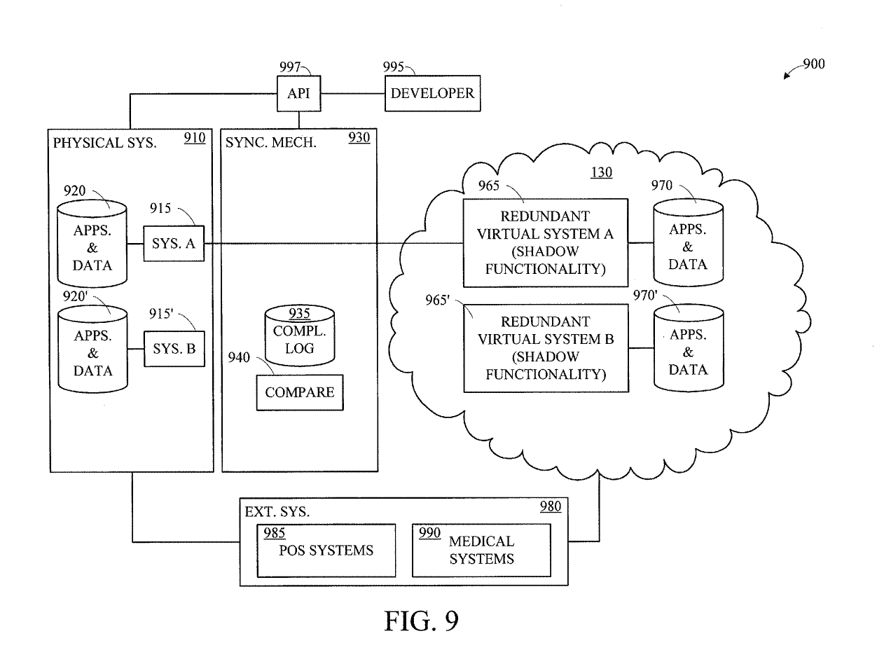

FIG. 9 is a block diagram illustrating an implementation of a shadow virtualization system 900. A number of physical systems 910 may be in operation, such as System A 915, along with its associated applications and data 920, and System B 915′, along with its associated applications and data 920′. A master copy of each personality (e.g., configuration, initialization parameters, or other suitable information) of the multiple remote systems 915, 915′ (collectively, or by way of example 915) is created and each system 915 is then virtualized into a working virtual machine 965, 965′ (e.g., a copy) of the original system in the cloud 130. This includes the associated applications and data 920, 920′, which are created as applications and data 970, 970′ in the cloud 130.

Since a virtual machine can have an arbitrary number of system CPUs and other resources assigned to it, the virtual machine(s) 965 are scalable to the size of the available hardware, or with cloud-based systems, to the maximum capacity of the cloud.

Although conventional virtualization methods result in a replication of the physical system, they do not provide for simultaneous operation of the physical and virtual (copy) systems (e.g., the systems 915 and systems 965) and for an effective mechanism for synchronizing the physical and virtual systems, which can result in the two systems becoming different (e.g., having different system states, stored data, etc.). Thus, a synchronization mechanism 930 may be provided that keeps the physical systems 915 and their respective applications and data 920 fully synchronized with their respective redundant virtual system 965 and its respective applications and data 970. The synchronization mechanism 930 may comprise management tools that keep track of the deployment of the virtual copies, modify specific characteristics of the virtual copy, such as the IP addresses, system name, and security information, so that images can coincide with one another without conflict. In an embodiment, the synchronization mechanism 930 is performed by the server-side 850. In another embodiment, the synchronization mechanism 930 is performed by a server 122 configured for handling synchronization of one, two, or more physical systems 915. In some embodiments, the synchronization mechanism 930 is performed by the client-side 810 or both the client-side 810 and the server-side 850 in cooperation with each other.

An application programming interface (API) 997 may be provided so that changes to the virtual copies made by developers 995 can be made through tested and validated API functions, and these functions can be called from programs or websites using industry standard HTTPS with SSL security.

The physical and virtual systems 915 and 965 may communicate with external systems 980 that utilize confidential data and/or require compliance with security and privacy regulations. For example, point of sale systems 985 may use credit card information that is subject to Payment Card Industry (PCI) rules. Medical systems 990 may use sensitive customer or patient data subject to Health Industry Privacy Act (HIPAA) regulations. The system may incorporate isolation technology as disclosed in U.S. Pat. Nos. 8,775,802 and/or 8,429,429, the contents of which are incorporated by reference herein. In some embodiments, the external systems 980 include a cryptocurrency system (e.g., Bitcoin, Ethereum, Litecoin, etc.; not shown) or other suitable digital payment system.

In various embodiments, the physical system 915 operates unchanged, and the running virtual copy 965 shadows selected operations of the physical system 915 for the functionality that is desired to be shadowed. In an embodiment, for example, the function of pricing an order is included in the desired shadow functionality. In this example, administration of the systems might involve using the synchronization mechanism 930 for duplicating pricing updates and menu changes to both the physical system 915 and running virtual copy 965. Synchronization by the synchronization mechanism 930 may be facilitated by implementing a timestamp in a completion log 935 for each update accomplished.

Additionally, remote procedures may be controlled by “triggers” that may be invoked based on a rule set that assures that when events occur on the physical system 915, the same event is “triggered” on the running virtual copy 965. Since some processes do not complete without a system restart, the trigger functionality assures that the physical 915 and virtual 965 systems are in the same state after an update is applied.

To assure that the system 900 is operating nominally, sample transactions may be applied periodically to both the physical 915 and running virtual copies 965, and the results of the transactions may be compared via a compare module 940 to assure that the results are the same. Discrepancies may be investigated to determine a source of the problem, and the systems 915, 965 can be re-synchronized to restore nominal operations even before the error has been corrected.

When the system is operating nominally, requests can be fulfilled by the running virtual system 965 without interference with the physical system 915. For example, orders can be priced, and then submitted fully complete from the running virtual system 965 to the physical system 915.

One benefit of this architecture is that it may provide much greater scalability and a faster turnaround time on updates and pricing changes, and eliminate a single point of failure, since the running virtual system 965 can also serve as a failover host for the remote stores (e.g., client-side 810) in the event of a failure of the physical system 915 (e.g., server-side 850) or a communication link to the physical system 915. The administrative system or synchronization mechanism 930 can then be used to restore operations to the physical system 915 when it has been repaired.

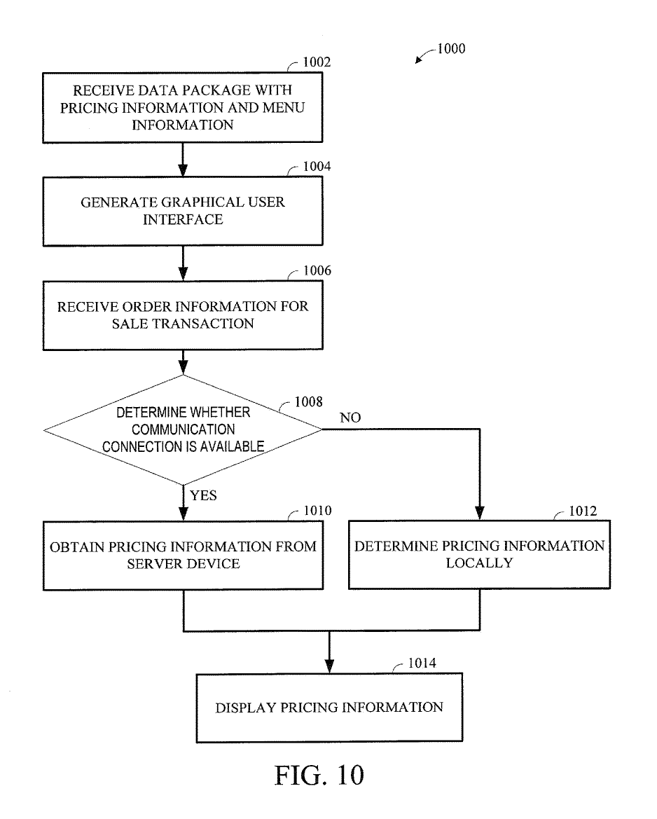

FIG. 10 is a flow diagram of an example method 1000 for displaying pricing information, according to an embodiment. In some embodiments, the client 112 is configured to perform the method 1000. In various embodiments, for example, the POS 540, client-side 810, a device executing the POS software 655, or other suitable device performs the method 1000.

At block 1002, a data package that includes client pricing information is received by a client device. The client pricing information is synchronized with server pricing information on a server device. In an embodiment, the client pricing information and the server pricing information correspond to the information 830 and information 830′, respectively, while the client device and server device correspond to the client-side 810 and the server-side 850, respectively.

At block 1004, a graphical user interface configured for sales transactions is generated by the client device. In an embodiment, the data package includes menu information for the sales transactions that is configured to be readable within a portable execution environment of the client device and the client device generates the graphical user interface based on the menu information. In some embodiments, the client device receives an updated data package (1002) and automatically generates an updated graphical user interface (1004). The graphical user interface includes one or more of menu items, a cart of selected items, pricing information (e.g., quantities, per-unit price, discounts, taxes, etc.), customer information, coupon information, recommended items or combinations of items, or other suitable information for sales transactions.

At block 1006, order information for a sales transaction is received by the client device via the graphical user interface. For example, an order (e.g., a cart) for a pizza with associated customer information, selected toppings, and side-order items is received.

At block 1008, the client device determines whether a communication connection is available between the client device and the server device for sales transactions. In some embodiments, step 1008 is performed for each sales transaction. In other embodiments, step 1008 is performed at various times, for example, initialization of the client device, generation of the graphical user interface, periodically (e.g., every 30 seconds, 5 minutes, etc.), when detected events occur (e.g., connection of a network plug), or other suitable times. In response to a determination that the communication connection is available, the client device proceeds to block 1010. In response to a determination that the communication connection is unavailable, the client device proceeds to block 1012.

At block 1010, the client device obtains pricing information for the sales transaction from the server device. The server device is located remotely from the client device and generates the pricing information based on server pricing information located remotely from the client device. In an embodiment, for example, the client device sends order information to the server device and the server device generates and sends back the pricing information to the client device. The server device generates the pricing information based on the information 830′ and using the order function 825′, in an embodiment.

At block 1012, the client device determines pricing information for the sales transaction, including generating the pricing information based on client pricing information located locally to the client device. The client device generates the pricing information based on the information 830 and using the order function 825, in an embodiment. In some embodiments, the data package includes executable instructions and information (e.g., information 830 and the order function 825).

In some embodiments, the client pricing information includes instructions that are configured to be executable within a portable execution environment of the client device for generation of the second pricing information. For example, the client device executes instructions within the client pricing information to determine the pricing information at block 1012. In an embodiment, the instructions of the client pricing information are configured to be executable within a portable execution environment of the server device for generation, by the server device, of the pricing information. For example, the server device executes the instructions within the client pricing information (using a copy stored for the server device, e.g., server pricing information) to determine the pricing information at block 1010. In an embodiment, both the client device and the server device provide a portable execution environment for execution of the instructions, as described above.

At block 1014, the pricing information is displayed by the client device via the graphical user interface. In various scenarios, the displayed pricing information is generated by the server device or by the client device, based on whether the communication connection is available. In some embodiments, the client device uploads a record of the sales transaction to the server device. In an embodiment, for example, the client device uploads the record (or a batch of records) after the communication connection becomes available.

In some scenarios, the client device continues performing one or more steps of the method 1000 for subsequent sales transactions. For example, the client device receives order information (1006), determines whether the communication connection is available (1008), obtains or determines pricing information (1010 or 1012), and displays the pricing information (1014). In some scenarios, the client device selectively obtains pricing information (1010) or determines pricing information (1012) dynamically based on the communication connection availability. Accordingly, when a communication connection is unavailable, a sales transaction can still be completed without communication with the server device during the sales transaction, and thus a high availability point of sale system is provided.

In some embodiments, a high availability point-of-sale (POS) system includes a POS device, a server device, and a synchronization module. The POS device includes a POS processor and a memory, the memory storing i) catalog information for at least one of products and services associated with a merchant, and ii) programmed logic that utilizes the catalog information of the POS device to provide an output related to a transaction with the merchant. The programmed logic of the POS device includes instructions configured to be executed on the POS processor. The server device includes a server processor and a memory, the memory storing i) catalog information for at least one of products and services associated with the merchant, and ii) programmed logic that utilizes the catalog information of the server device to provide an output related to a transaction with the merchant. The programmed logic of the server device includes instructions configured to be executed on the server processor. The synchronization module synchronizes the catalog information of the POS device with the catalog information of the server device and synchronizes the programmed logic of the POS device with the programmed logic of the server device. In an embodiment, the POS device, the server device, and the synchronization module correspond to the client-side 810, the server-side 850, and the synchronization function 860, respectively.

In an embodiment, a method implemented on a client device for displaying pricing information includes: generating, by the client device, a graphical user interface configured for sales transactions; receiving, by the client device, first order information for a first sales transaction via the graphical user interface; obtaining, by the client device and from a server device located remotely from the client device, first pricing information for the first sales transaction, the first pricing information being generated by the server device based on server pricing information located remotely from the client device; displaying, by the client device, the first pricing information via the graphical user interface; receiving, by the client device, second order information for a second sales transaction via the graphical user interface; determining, by the client device, second pricing information for the second sales transaction, including generating the second pricing information based on client pricing information located locally to the client device; and displaying, by the client device, the second pricing information via the graphical user interface.

In other embodiments, the method includes any suitable combination of one or more of the following features.

The method further includes receiving, by the client device, a data package that includes the client pricing information, wherein the client pricing information is synchronized with the server pricing information.

The client pricing information includes instructions that are configured to be executable within a portable execution environment of the client device for generation of the second pricing information.

The instructions of the client pricing information are configured to be executable within a portable execution environment of the server device for generation, by the server device, of the first pricing information.

The portable execution environment of the client device and the portable execution environment of the server device are JavaScript execution environments.

The data package further includes menu information for the sales transactions that is configured to be readable within the portable execution environment of the client device. The method further includes generating the graphical user interface based on the menu information.

The menu information is configured to be readable within the portable execution environment of the server device.

The method further includes performing the second sales transaction without communication with the server device during the second sales transaction.

The method further includes determining whether a communication connection is available between the client device and the server device for the second sales transaction; wherein the client device determines the second pricing information when the communication link is determined to be unavailable for the second sales transaction.

The method further includes uploading a record of the second sales transaction to the server device.

In another embodiment, a client device for displaying pricing information includes a non-transitory computer-readable memory and a hardware processor. The hardware processor generates a graphical user interface configured for sales transactions; receives first order information for a first sales transaction via the graphical user interface; obtains, from a server device located remotely from the client device, first pricing information for the first sales transaction, the first pricing information being generated by the server device based on server pricing information located remotely from the client device; displays the first pricing information via the graphical user interface; receives second order information for a second sales transaction via the graphical user interface; determines second pricing information for the second sales transaction, including generating the second pricing information based on client pricing information located locally to the client device; and displays the second pricing information via the graphical user interface.

In other embodiments, the client device includes any suitable combination of one or more of the following features.

The client device receives a data package that includes the client pricing information, wherein the client pricing information is synchronized with the server pricing information.

The client pricing information includes instructions that are configured to be executable within a portable execution environment of the client device for generation of the second pricing information.

The instructions of the client pricing information are configured to be executable within a portable execution environment of the server device for generation, by the server device, of the first pricing information.

The portable execution environment of the client device and the portable execution environment of the server device are JavaScript execution environments.

The data package further includes menu information for the sales transactions that is configured to be readable within the portable execution environment of the client device, wherein the hardware processor generates the graphical user interface based on the menu information.

The menu information is configured to be readable within the portable execution environment of the server device.

The client device performs the second sales transaction without communication with the server device during the second sales transaction.

The hardware processor determines whether a communication connection is available between the client device and the server device for the second sales transaction; wherein the hardware processor determines the second pricing information when the communication link is determined to be unavailable for the second sales transaction.

The hardware processor uploads a record of the second sales transaction to the server device.

### Variations

All or a portion of aspects of the invention described herein can be implemented using a general purpose computer/processor with a computer program that, when executed, carries out any of the respective techniques, algorithms and/or instructions described herein. In addition, or alternatively, for example, a special purpose computer/processor can be utilized which can contain specialized hardware for carrying out any of the techniques, algorithms, or instructions described herein.

The implementations of computing devices as described herein (and the algorithms, methods, instructions, etc., stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination.

For example, one or more computing devices can include an ASIC or programmable logic array such as a field-programmable gate array (FPGA) configured as a special-purpose processor to perform one or more of the operations or operations described or claimed herein. An example FPGA can include a collection of logic blocks and random access memory (RAM) blocks that can be individually configured and/or configurably interconnected in order to cause the FPGA to perform certain functions. Certain FPGA's may contain other general or special purpose blocks as well. An example FPGA can be programmed based on a hardware definition language (HDL) design, such as VHSIC Hardware Description Language or Verilog.

The embodiments herein may be described in terms of functional block components and various processing operations. Such functional blocks may be realized by any number of hardware and/or software components that perform the specified functions. For example, the described embodiments may employ various integrated circuit components, e.g., memory elements, processing elements, logic elements, look-up tables, and the like, which may carry out a variety of functions under the control of one or more microprocessors or other control devices. Similarly, where the elements of the described embodiments are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the embodiments of the invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

Implementations or portions of implementations of the above disclosure can take the form of a computer program product accessible from, for example, a computer-usable or computer-readable medium. A computer-usable or computer-readable medium can be any device that can, for example, tangibly contain, store, communicate, or transport a program or data structure for use by or in connection with any processor. The medium can be, for example, an electronic, magnetic, optical, electromagnetic, or a semiconductor device. Other suitable mediums are also available. Such computer-usable or computer-readable media can be referred to as non-transitory memory or media, and may include RAM or other volatile memory or storage devices that may change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. In other words, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. Many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) should be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the operations of all methods described herein are performable in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

All references, including publications, patent applications, and patents, cited herein are hereby incorporated by reference to the same extent as if each reference were individually and specifically indicated as incorporated by reference and were set forth in its entirety herein.

The above-described embodiments have been described in order to allow easy understanding of the present invention and do not limit the present invention. To the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method implemented on a client device for displaying pricing information, the method comprising:
generating, by the client device, a graphical user interface configured for sales transactions;
receiving, by the client device, first order information for a first sales transaction via the graphical user interface;
obtaining, by the client device and from a server device located remotely from the client device, first pricing information for the first sales transaction, the first pricing information being generated by the server device based on server pricing information located remotely from the client device;
displaying, by the client device, the first pricing information via the graphical user interface;
receiving, by the client device, second order information for a second sales transaction via the graphical user interface;
determining, by the client device, second pricing information for the second sales transaction, including generating the second pricing information based on client pricing information located locally to the client device; and
displaying, by the client device, the second pricing information via the graphical user interface.

2. The method of claim 1, further comprising receiving, by the client device, a data package that includes the client pricing information, wherein the client pricing information is synchronized with the server pricing information.

3. The method of claim 2, wherein the client pricing information includes instructions that are configured to be executable within a portable execution environment of the client device for generation of the second pricing information.

4. The method of claim 3, wherein the instructions of the client pricing information are configured to be executable within a portable execution environment of the server device for generation, by the server device, of the first pricing information.

5. The method of claim 4, wherein the portable execution environment of the client device and the portable execution environment of the server device are JavaScript execution environments.

6. The method of claim 4, wherein the data package further includes menu information for the sales transactions that is configured to be readable within the portable execution environment of the client device, wherein generating the graphical user interface comprises generating the graphical user interface based on the menu information.

7. The method of claim 6, wherein the menu information is configured to be readable within the portable execution environment of the server device.

8. The method of claim 2, further comprising performing the second sales transaction without communication with the server device during the second sales transaction.

9. The method of claim 8, further comprising determining whether a communication connection is available between the client device and the server device for the second sales transaction;
wherein the client device determines the second pricing information when the communication link is determined to be unavailable for the second sales transaction.

10. The method of claim 9, further comprising uploading a record of the second sales transaction to the server device.

11. A client device for displaying pricing information, the client device comprising:
a non-transitory computer-readable memory;
a hardware processor that:
generates a graphical user interface configured for sales transactions;
receives first order information for a first sales transaction via the graphical user interface;
obtains, from a server device located remotely from the client device, first pricing information for the first sales transaction, the first pricing information being generated by the server device based on server pricing information located remotely from the client device;
displays the first pricing information via the graphical user interface;
receives second order information for a second sales transaction via the graphical user interface;
determines second pricing information for the second sales transaction, including generating the second pricing information based on client pricing information located locally to the client device; and
displays the second pricing information via the graphical user interface.

12. The client device of claim 11, wherein the client device receives a data package that includes the client pricing information, wherein the client pricing information is synchronized with the server pricing information.

13. The client device of claim 12, wherein the client pricing information includes instructions that are configured to be executable within a portable execution environment of the client device for generation of the second pricing information.

14. The client device of claim 13, wherein the instructions of the client pricing information are configured to be executable within a portable execution environment of the server device for generation, by the server device, of the first pricing information.

15. The client device of claim 14, wherein the portable execution environment of the client device and the portable execution environment of the server device are JavaScript execution environments.

16. The client device of claim 14, wherein the data package further includes menu information for the sales transactions that is configured to be readable within the portable execution environment of the client device, wherein the hardware processor generates the graphical user interface based on the menu information.

17. The client device of claim 16, wherein the menu information is configured to be readable within the portable execution environment of the server device.

18. The client device of claim 12, wherein the client device performs the second sales transaction without communication with the server device during the second sales transaction.

19. The client device of claim 18, wherein the hardware processor determines whether a communication connection is available between the client device and the server device for the second sales transaction;
wherein the hardware processor determines the second pricing information when the communication link is determined to be unavailable for the second sales transaction.

20. The client device of claim 19, wherein the hardware processor uploads a record of the second sales transaction to the server device.
